(19) United States
(12) Patent Application Publication
(10) Pub. No.: US 2026/0226277 A1
(43) Pub. Date: Aug. 6, 2026

(54) LIGHT-CURABLE RESIN MATERIAL, MANUFACTURING METHOD THEREOF, AND CURING METHOD THEREOF

(71) Applicant: ASUSTEK COMPUTER INC., TAIPEI (TW)

(72) Inventors: Guo-Lin YANG, TAIPEI (TW); Po-Wen HUANG, TAIPEI (TW); Yu-Chun YANG, TAIPEI (TW); Er-Bao NIU, TAIPEI (TW); Tao CHEN, TAIPEI (TW)

(21) Appl. No.: 19/214,325

(22) Filed: May 21, 2025

(30) Foreign Application Priority Data
Feb. 5, 2025 (TW) 114104178

(51) Int. Cl. C08L 101/02; C08K 5/00; C09D 201/02

(52) U.S. Cl. CPC C08L 101/02; C08K 5/0025; C08K 5/0041; C09D 201/02; C08L 2205/03

(57) ABSTRACT

A light-curable resin material is provided, which comprises a first light-curable resin, a second light-curable resin, and a third light-curable resin. The first light-curable resin is synthesized from a first polymeric resin material and a first photo-initiating material. The second light-curable resin is synthesized from a second polymeric resin material and a second photo-initiating material. The third light-curable resin synthesized from a third polymeric resin material and a third photo-initiating material. The first polymeric resin material, the second polymeric resin material, and the third polymeric resin material are all synthesized by reacting a first prepolymer and a second prepolymer. A manufacturing method and curing method thereof are also provided.

### CROSS-REFERENCE TO RELATED APPLICATION

This application claims the priority benefit of Taiwan application serial No. 114104178, filed on Feb. 5, 2025. The entirety of the above-mentioned patent application is hereby incorporated by reference herein and made a part of the specification.

### BACKGROUND OF THE INVENTION

### Field of the Invention

The present invention relates to a light-curable resin material, a manufacturing method, and a curing method thereof.

### Description of the Related Art

Conventional light-curable resin coatings are made by utilizing ultraviolet (UV) light, instead of a heat source, to cure liquid resin coatings to form a coating. The light-curable resin materials are widely applied to protective coatings of housings for electronic device.

However, coatings formed by conventional light-curable resin coatings are not smooth, and elasticity is poor.

### BRIEF SUMMARY OF THE INVENTION

A light-curable resin material is provided. The light-curable resin material comprises a first light-curable resin synthesized from a first polymeric resin material and a first photo-initiating material; a second light-curable resin synthesized from a second polymeric resin material and a second photo-initiating material; and a third light-curable resin synthesized from a third polymeric resin material and a third photo-initiating material; wherein the first polymeric resin material, the second polymeric resin material, and the third polymeric resin material are all synthesized by reacting a first prepolymer and a second prepolymer, the first prepolymer is different from the second prepolymer, and weight ratios of the first prepolymer to the second prepolymer in the first polymeric resin material, the second polymeric resin material, and third polymeric resin material are all different, the first photo-initiating material, the second photo-initiating material, and the third photo-initiating material are synthesized from a photoinitiator and a curing accelerator, respectively, and proportions of the curing accelerator in the first photo-initiating material, the second photo-initiating material, and the third photo-initiating material are all different.

A manufacturing method adapted for producing a light-curable resin material is also provided. The manufacturing method comprises: reacting a first prepolymer and a second prepolymer to synthesize a first polymeric resin material, a second polymeric resin material, and a third polymeric resin material, wherein weight ratios of the first prepolymer to the second prepolymer in the second polymeric resin material and the third polymeric resin material are all different; synthesizing a first photo-initiating material, a second photo-initiating material, and a third photo-initiating material by reacting a photoinitiator and a curing accelerator, wherein the proportions of the curing accelerator in the first photo-initiating material, the second photo-initiating material, and the third photo-initiating material are all different; synthesizing the first light-curable resin by reacting the first polymeric resin material and the first photo-initiating material, synthesizing the second light-curable resin by reacting the second polymeric resin material and the second photo-initiating material to, and synthesizing the third light-curable resin by reacting the third polymeric resin material and the third photo-initiating material; and mixing the first light-curable resin, the second light-curable resin, and the third light-curable resin to obtain the light-curable resin material.

A curing method adapted for curing the light-curable resin material is also provided. The curing method comprises: forming a wet film on a substrate via the light-curable resin material; forming a pre-cured film by irradiating the wet film with a light-emitting diode (LED) light source; irradiating the pre-cured film with an excimer light source to form a reaction-cured film; and irradiating the reaction-cured film with an ultraviolet light source to form a fully cured film.

Unlike conventional light-curable resin coatings, which are unsmooth and have insufficient elasticity, the cured film layers formed by the light-curable resin material in embodiments are smooth and elastic.

### BRIEF DESCRIPTION OF THE DRAWINGS

FIG. 1 illustrates a flowchart of a manufacturing method of a light-curable resin material according to an embodiment;

FIG. 2 illustrates a flowchart of a manufacturing method of a light-curable resin material according to another embodiment; and

FIG. 3 illustrates a flowchart of a curing method according to an embodiment.

### DETAILED DESCRIPTION OF THE EMBODIMENTS

The embodiments of the invention are disclosed in detail accompanying following figures. Advantages and features of the application are clearer according to following descriptions and claims. The drawings are shown in a simplified form and imprecise proportions to conveniently and clearly assist to explain purposes of the embodiments.

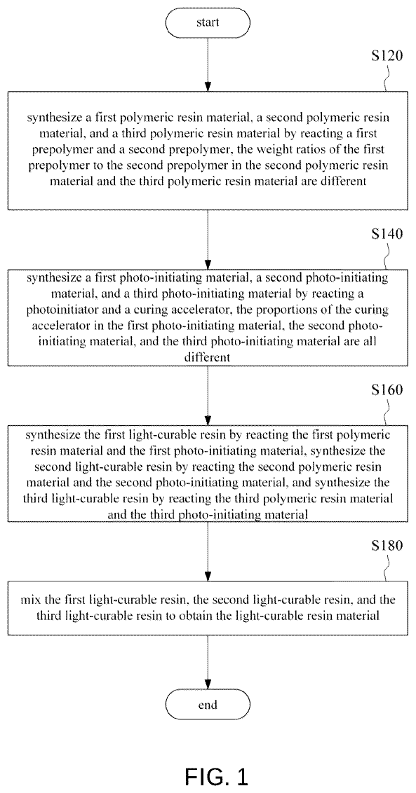

FIG. 1 illustrates a flowchart of a manufacturing method of a light-curable resin material according to an embodiment.

The light-curable resin material includes a first light-curable resin, a second light-curable resin, and a third light-curable resin.

The first light-curable resin is synthesized from a first polymeric resin material and a first photo-initiating material. The second light-curable resin is synthesized from a second polymeric resin material and a second photo-initiating material. The third light-curable resin is synthesized from a third polymeric resin material and a third photo-initiating material. The first polymeric resin material, the second polymeric resin material, and the third polymeric resin material are synthesized by reacting a first prepolymer and a second prepolymer, respectively. The first prepolymer is different from the second prepolymer. Weight ratios of the first prepolymer to the second prepolymer in the first polymeric resin material, the second polymeric resin material, and the third polymeric resin material are all different.

The first photo-initiating material, the second photo-initiating material, and the third photo-initiating material are synthesized by reacting a photoinitiator and a curing accelerator, respectively. Proportions of the curing accelerator in the first photo-initiating material, the second photo-initiating material, and the third photo-initiating material are all different.

The manufacturing method includes the following steps.

First, as described in step S120, a first polymeric resin material, a second polymeric resin material, and a third polymeric resin material are synthesized by reacting a first prepolymer and a second prepolymer. The weight ratios of the first prepolymer to the second prepolymer in the second polymeric resin material and the third polymeric resin material are different.

For example, the weight ratio of the first prepolymer to the second prepolymer in the second polymeric resin material is 1:1, the weight ratio of the first prepolymer to the second prepolymer in the second polymeric resin material is 1:2, and the weight ratio of the first prepolymer to the second prepolymer in the third polymeric resin material is 2:1.

In an embodiment, three synthesized polymeric resin materials, that is, the first polymeric resin material, the second polymeric resin material, and the third polymeric resin material, are stirred at a high speed for 6-8 hours in a low-temperature environment (<22° C.) and left to stand sealed in the same environment for 12-24 hours, and then 80%-85% of volume is filtered out via a 2000-mesh pneumatic sieve for subsequent use.

Subsequently, as described in step S140, a first photo-initiating material, a second photo-initiating material, and a third photo-initiating material are synthesized by reacting a photoinitiator and a curing accelerator. The proportions of the curing accelerator in the first photo-initiating material, the second photo-initiating material, and the third photo-initiating material are all different.

In one embodiment, the curing accelerator in the first photo-initiating material has a first proportion, the curing accelerator in the second photo-initiating material has a second proportion, and the curing accelerator in the third photo-initiating material has a third proportion. The first proportion is less than the second proportion, and the second proportion is less than the third proportion. For example, the first proportion is between 40 wt % and 50 wt %, the second proportion is between 50 wt % and 60 wt %, and the third proportion is between 60 wt % and 70 wt %.

In one embodiment, the three synthesized photo-initiating materials, that is the first photo-initiating material, the second photo-initiating material, and the third photo-initiating material, are stirred at a low speed in a low-temperature environment (<22° C.) for 30-60 minutes for subsequent use.

Next, as described in step S160, the first light-curable resin is synthesized by reacting the first polymeric resin material and the first photo-initiating material, the second light-curable resin is synthesized by reacting the second polymeric resin material and the second photo-initiating material, and the third light-curable resin is synthesized by reacting the third polymeric resin material and the third photo-initiating material.

In one embodiment, the proportion of the first photo-initiating material in the first light-curable resin is between 1 wt % and 5 wt %, the weight percentage of the second photo-initiating material in the second light-curable resin is between 1 wt % and 5 wt %, and the weight percentage of the third photo-initiating material in the third light-curable resin is between 1 wt % and 5 wt %.

In one embodiment, the aforementioned reaction-synthesized the first light-curable resin, the second light-curable resin, and the third light-curable resin are stirred at a high speed for 2-3 hours in a low-temperature environment (<22° C.) and left to stand sealed in the same environment for 24-36 hours, and then 70%-80% of volume is filtered out via a 2000-mesh pneumatic sieve for subsequent use.

Then, as described in step S180, the first light-curable resin, the second light-curable resin, and the third light-curable resin are mixed to obtain the light-curable resin material.

In one embodiment, in step S180, the first light-curable resin, the second light-curable resin, the third light-curable resin, an additive, and a solvent are mixed to obtain the light-curable resin material. The additive and the solvent used in the light-curable resin material are well-known in the field and not described again for a concise purpose.

In one embodiment, the ratio of the first light-curable resin, the second light-curable resin, and the third light-curable resin in step S180 is 1:1:1, which is not limited herein. Furthermore, in one embodiment, the light-curable resin material synthesized in step S180 is stirred at a high speed for 15-25 hours in a low-temperature environment (<22° C.) and left to stand sealed in the same environment for more than 36 hours, and then 65%-70% of volume is filtered out via a 2000-mesh pneumatic sieve for subsequent use.

According to the above manufacturing method, the step S120 is processed to obtain the first polymeric resin material, the second polymeric resin material, and the third polymeric resin material with different component proportions, and then step S140 is processed to obtain the first photo-initiating material, the second photo-initiating material, and the third photo-initiating material with different proportions of the curing accelerator, which is not limited herein. In other embodiments, the steps S120 and S140 are processed simultaneously, or step S140 is processed before the step S120.

Furthermore, in the manufacturing method, the three light-curable resins (that is, the first light-curable resin, the second light-curable resin, and the third light-curable resin) are synthesized by reacting the three polymeric resin materials with different component proportions obtained in step S120 (that is, the first polymeric resin material, the second polymeric resin material, and the third polymeric resin material) and the three photo-initiating materials with different proportions of curing accelerator obtained in step S140 (that is, the first photo-initiating material, the second photo-initiating material, and the third photo-initiating material), which is not limited herein.

In an embodiment, four or more polymeric resin materials with different component proportions are reacted with four or more photo-initiating materials with different proportions of the curing accelerator to synthetize four or more light-curable resins.

Furthermore, in other embodiments, three polymeric resin materials obtained in the step S120 are reacted with three photo-initiating materials obtained in step S140 to synthetize four or more light-curable resins. For example, except for the way that the first light-curable resin is synthesized by reacting the first polymeric resin material and the first photo-initiating material, the second light-curable resin is synthesized by reacting the second polymeric resin material and the second photo-initiating material, and the third light-curable resin is synthesized by reacting the third polymeric resin material and the third photo-initiating material as described in step S160, different light-curable resins are synthesized by reacting the first polymeric resin material with the first photo-initiating material or the second photo-initiating material, by reacting the second polymeric resin material with the first photo-initiating material or the third photo-initiating material, or by reacting the third polymeric resin material with the first photo-initiating material or the second photo-initiating material, which is not limited herein.

Additionally, in the aforementioned embodiment, three light-curable resins (that is, the first light-curable resin, the second light-curable resin, and the third light-curable resin) are mixed to obtain the light-curable resin material, which is not limited herein. In other embodiments, more light-curable resins (for example, four or more) are mixed to obtain the light-curable resin material.

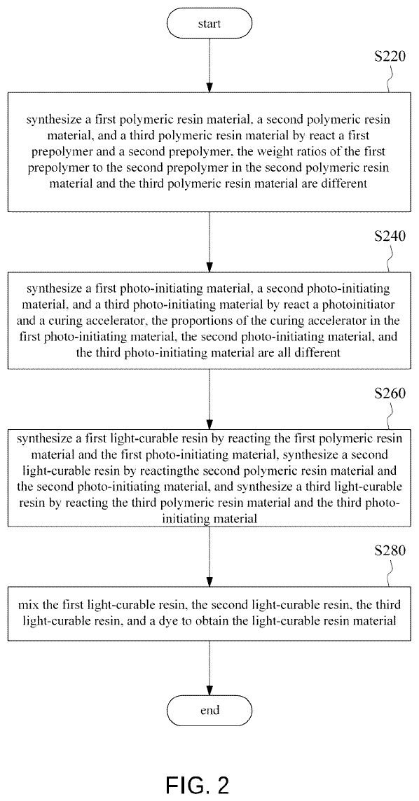

FIG. 2 illustrates a flowchart of a manufacturing method of a light-curable resin material according to another embodiment. The manufacturing method includes the following steps:

First, as described in step S220, a first polymeric resin material is synthesized by reacting a first prepolymer and a second prepolymer, a second polymeric resin material, and a third polymeric resin material. The weight ratios of the first prepolymer to the second prepolymer in the second polymeric resin material and the third polymeric resin material are different. This step is similar to step S120 in FIG. 1.

Subsequently, as described in step S240, a first photo-initiating material is synthesized by reacting a photoinitiator and a curing accelerator, a second photo-initiating material, and a third photo-initiating material. The proportions of the curing accelerator in the first photo-initiating material, the second photo-initiating material, and the third photo-initiating material are all different. Step S240 is similar to step S140 in FIG. 1.

Next, as described in step S260, the first light-curable resin is synthesized by reacting the first polymeric resin material and the first photo-initiating material, the second light-curable resin is synthesized by reacting the second polymeric resin material and the second photo-initiating material, and the third light-curable resin is synthesized by reacting the third polymeric resin material and the third photo-initiating material. The step S260 is similar to step S160 in FIG. 1.

Then, in step S280, the first light-curable resin, the second light-curable resin, the third light-curable resin, and a dye are mixed to obtain the light-curable resin material. Compared to the manufacturing method described in FIG. 1, a dye is added to the light-curable resin material in step S280, which adjusts the color of the light-curable resin material to meet practical usage requirements.

Additionally, in the manufacturing method described in the embodiment, three light-curable resins (that is, the first light-curable resin, the second light-curable resin, and the third light-curable resin) are mixed to obtain the light-curable resin material of this case, which is not limited herein. In other embodiments, more types of light-curable resins (for example, four or more) are mixed to obtain the light-curable resin material.

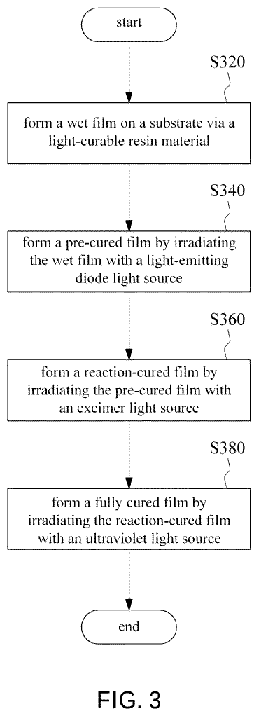

FIG. 3 shows a flowchart of the curing method according to an embodiment. The curing method is adapted to cure the light-curable resin materials manufactured by the manufacturing methods shown in FIG. 1 and FIG. 2.

As shown in FIG. 3, the curing method includes the following steps. First, as described in step S320, a wet film is formed on a substrate via a light-curable resin material. The wet film is a surface layer in a liquid state. In one embodiment, the thickness of the wet film ranges from 20 to 30 micrometers.

Subsequently, as described in step S340, a pre-cured film is formed by irradiating the wet film with a light-emitting diode light (LED) source. In one embodiment, the light-emitting diode light source is a visible light-emitting diode light source.

Next, as described in step S360, a reaction-cured film is formed by irradiating the pre-cured film with an excimer light source. In one embodiment, the wavelength of the excimer light source ranges from 200 nm to 400 nm.

Then, as described in step S380, the reaction-cured film is irradiated with an ultraviolet light source to form a fully cured film. In one embodiment, the ultraviolet light source is a mercury lamp light source.

Unlike conventional light-curable resin coatings, which are unsmooth and have insufficient elasticity, the cured film layers formed by the light-curable resin material in embodiments are smooth and elastic. Additionally, the light-curable resin materials in embodiments are adapted to cooperate with excimer light sources of different wavelength ranges, and a problem of unstable excimer wavebands is effectively solved.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A light-curable resin material, comprising:
a first light-curable resin synthesized from a first polymeric resin material and a first photo-initiating material;
a second light-curable resin synthesized from a second polymeric resin material and a second photo-initiating material; and
a third light-curable resin synthesized from a third polymeric resin material and a third photo-initiating material;
wherein the first polymeric resin material, the second polymeric resin material, and the third polymeric resin material are all synthesized by reacting a first prepolymer and a second prepolymer, the first prepolymer is different from the second prepolymer, and weight ratios of the first prepolymer to the second prepolymer in the first polymeric resin material, the second polymeric resin material, and third polymeric resin material are all different,
the first photo-initiating material, the second photo-initiating material, and the third photo-initiating material are synthesized from a photoinitiator and a curing accelerator, respectively, and proportions of the curing accelerator in the first photo-initiating material, the second photo-initiating material, and the third photo-initiating material are all different.

2. The light-curable resin material according to claim 1, wherein the curing accelerator in the first photo-initiating material has a first proportion, the curing accelerator in the second photo-initiating material has a second proportion, the curing accelerator in the third photo-initiating material has a third proportion, the first proportion is less than the second proportion, and the second proportion is less than the third proportion.

3. The light-curable resin material according to claim 2, wherein the first proportion is between 40 wt % and 50 wt %, the second proportion is between 50 wt % and 60 wt %, and the third proportion is between 60 wt % and 70 wt %.

4. The light-curable resin material according to claim 1, wherein the proportion of the first prepolymer in the first polymeric resin material is higher than that in the second polymeric resin material, but lower than that in the third polymeric resin material.

5. The light-curable resin material according to claim 4, wherein the weight ratio of the first prepolymer to the second prepolymer in the second polymeric resin material is 1:1, the weight ratio of the first prepolymer to the second prepolymer in the second polymeric resin material is 1:2, and the weight ratio of the first prepolymer to the second prepolymer in the third polymeric resin material is 2:1.

6. The light-curable resin material according to claim 1, further comprising a dye.

7. The light-curable resin material according to claim 1, wherein the proportion of the first photo-initiating material in the first light-curable resin is between 1 wt % and 5 wt %.

8. A manufacturing method, adapted for producing a light-curable resin material, comprising:
reacting a first prepolymer and a second prepolymer to synthesize a first polymeric resin material, a second polymeric resin material, and a third polymeric resin material, wherein weight ratios of the first prepolymer to the second prepolymer in the second polymeric resin material and the third polymeric resin material are different;
synthesizing a first photo-initiating material, a second photo-initiating material, and a third photo-initiating material by reacting a photoinitiator and a curing accelerator, wherein the proportions of the curing accelerator in the first photo-initiating material, the second photo-initiating material, and the third photo-initiating material are all different;
synthesizing a first light-curable resin by reacting the first polymeric resin material and the first photo-initiating material, synthesizing a second light-curable resin by reacting the second polymeric resin material and the second photo-initiating material, and synthesizing a third light-curable resin by reacting the third polymeric resin material and the third photo-initiating material; and
mixing the first light-curable resin, the second light-curable resin, and the third light-curable resin to obtain the light-curable resin material.

9. The manufacturing method according to claim 8, wherein the step of mixing the first light-curable resin, the second light-curable resin, and the third light-curable resin to obtain the light-curable resin material is a step of mixing the first light-curable resin, the second light-curable resin, the third light-curable resin, an additive, and a solvent to obtain the light-curable resin material.

10. A curing method, adapted for curing the light-curable resin material according to claim 1, comprising:
forming a wet film on a substrate via the light-curable resin material;
forming a pre-cured film by irradiating the wet film with a light-emitting diode (LED) light source;
irradiating the pre-cured film with an excimer light source to form a reaction-cured film; and
irradiating the reaction-cured film with an ultraviolet light source to form a fully cured film.

11. The curing method according to claim 10, wherein the excimer light source has a wavelength between 200 nm and 400 nm.

12. The curing method according to claim 10, wherein the UV light source is a mercury lamp.

13. The curing method according to claim 10, wherein the wet film has a thickness between 20 μm and 30 μm.
